(19) United States
(12) Patent Application Publication
(10) Pub. No.: US 2016/0012129 A1
(43) Pub. Date: Jan. 14, 2016

(54) VISUALIZATION SUGGESTIONS

(71) Applicant: Microsoft Technology Licensing, LLC, Redmond, WA (US)

(72) Inventors: Benjamin Edward Rampson, Woodinville, WA (US); Nickolas Dwayne Welton, Seattle, WA (US); Christopher John Gross, Redmond, WA (US); Poornima Hanumara, Seattle, WA (US); Andrew Grey Carlson, Redmond, WA (US)

(21) Appl. No.: 14/330,337

(22) Filed: Jul. 14, 2014

(51) Int. Cl. G06F 17/30

(52) U.S. Cl. CPC G06F 17/30864

(57) ABSTRACT

Technologies are described herein for providing visualization suggestions. In order to provide a visualization suggestion, visualized data may be received. The visualized data may have profile data associated therewith and have at least one data connection to a data source associated therewith. Prior visualization information related to the profile data or the data connection may then be identified such that a visualization suggestion based on the identified prior visualization information can be determined. The visualization suggestion may then be returned to a client.

### BACKGROUND

It can be difficult for users of certain types of applications, such as spreadsheet applications, to create reports that provide effective visualizations of data. For example, a user of a spreadsheet application may connect a workbook to an external data source in order to build a report. After the user has added the data they are interested in to the report, there may still be many steps for the user to complete in order to get their report into suitable form for consumption by others. For example, the user may need to make decisions about how to filter the data in the report. This, however, may be difficult because the user may need to know the field names of the data source to filter upon. Additionally, the user may need to know how best to arrange and display the data in the report. Furthermore, the user may need to know how best to format the data in the report for display.

Because these and other decisions may need to be made by a user in order to create an effective report, the learning curve to create a good report may be high for some users. Consequently, some users may be discouraged from starting a report, or end up creating a report that is less than optimal for their particular data set.

It is with respect to these and other considerations that the disclosure made herein is presented.

### SUMMARY

Technologies are described herein for providing visualization suggestions. In order to provide a visualization suggestion (e.g., for visualization of data in a report and have one or more data connections to data sources associated therewith). Prior visualization information related to the profile data or the data connection may then be identified such that a visualization suggestion based on the identified prior visualization information can be determined. The visualization suggestion may then be returned to a client.

It should be appreciated that the above-described subject matter may also be implemented as a computer-controlled apparatus, a computer-implemented process, a computing system, or as an article of manufacture such as a computer-readable medium. Although the technologies presented herein are primarily disclosed in the context of providing visualization suggestions, the concepts and technologies disclosed herein might also be utilized to provide additional forms of suggestions based on any form of visualized data. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components disclosed herein;

FIG. 2 is a flow diagram showing aspects of one illustrative routine for collecting and storing prior visualization information;

FIG. 3 is a flow diagram showing aspects of one illustrative routine for providing visualization suggestions;

FIGS. 4A-4E are UI diagrams showings aspects of several illustrative UIs, according to several configurations presented herein;

FIG. 5 is a computer architecture diagram showing an illustrative computer hardware and software architecture for implementing the technologies disclosed herein;

FIG. 6 is a diagram illustrating a distributed computing environment capable of implementing aspects of the technologies presented herein; and

FIG. 7 is a computer architecture diagram illustrating a computing device architecture capable of implementing aspects of the technologies presented herein.

### DETAILED DESCRIPTION

The following detailed description is directed to technologies for providing visualization suggestions. The visualization suggestions may be implemented through a graphical UI or an element thereof. The visualization suggestions may be based, at least in part, upon prior visualization information. The prior visualization information may leverage the structure of previous data visualizations such that new data visualizations having similar data connections can be produced relatively quickly as compared with production without assistance.

As discussed briefly above, some users may have difficulty assembling appropriate or desirable visualizations of data, including reports or data reports. Utilizing an implementation of the technologies disclosed herein, however, visualization suggestions can be provided such that visualized data has a desired structure. Accordingly, an implementation of the technologies disclosed herein may require reduced effort from users wishing to visualize data. Additionally, utilizing the technologies disclosed herein, consistent data visualizations across groups of users may be realized based on profile data. Although listed separately, it should be appreciated that the results described above may be achieved individually, independently, or in partial/full combination according to any desired implementation of the technologies disclosed herein. Moreover, additional benefits can become apparent through implementation of the technologies described herein.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific technologies or examples. Referring now to the drawings, in which like numerals represent like elements throughout the several FIGS., aspects of a computing system and methodology for providing visualization suggestions will be described.

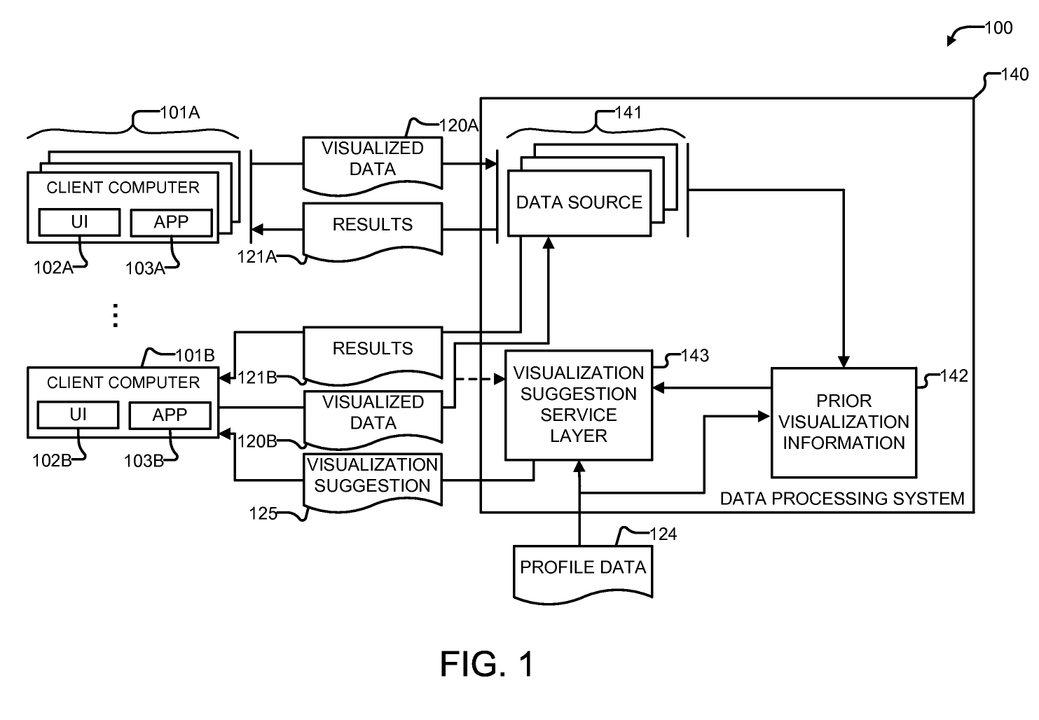

Turning now to FIG. 1, details will be provided regarding an illustrative operating environment and several software components disclosed herein. In particular, FIG. 1 shows aspects of a system 100 for providing visualization suggestions. The system 100 includes one or more client computers 101A and 101B (which may be referred to herein in the singular as a “client 101” and/or in the plural as the “clients 101”) in operative communication with a data processing system 140. The clients 101 may be any suitable computer systems including, but not limited to, desktop or laptop personal computers, tablet computing devices, smartphones, other types of mobile devices, or the like.

The clients 101 may be configured to execute software products, such as applications 103 that provide user interfaces 102 for the creation, editing, and/or submitting of visualized data 120 of information stored or processed at the data processing system 140 or locally at the client computers 101. In this regard, the clients 101 may provide one or more forms of visualized data 120A and receive results 121A in response thereto. The visualized data 120A may be in any appropriate form, including, but not limited to, spreadsheets, data reports, graphical documents, a combination of the same, or in any other suitable form.

The visualized data 120A may include particular data connections represented as queries or other similar statements, which may be embedded therein for retrieving data from one or more data sources 141. The visualized data 120A may therefore include instructions for visualizing or graphically displaying results 121A according to some implementations. The visualized data 120A may also include structural information related to results 121A, for example, information describing a layout, ordering, sorting, or other structural information. The visualized data 120A may also include a plurality of graphical elements, or instructions for generating the same, included therein, with the graphical elements specifying one or more queries of data from data sources 141 to display.

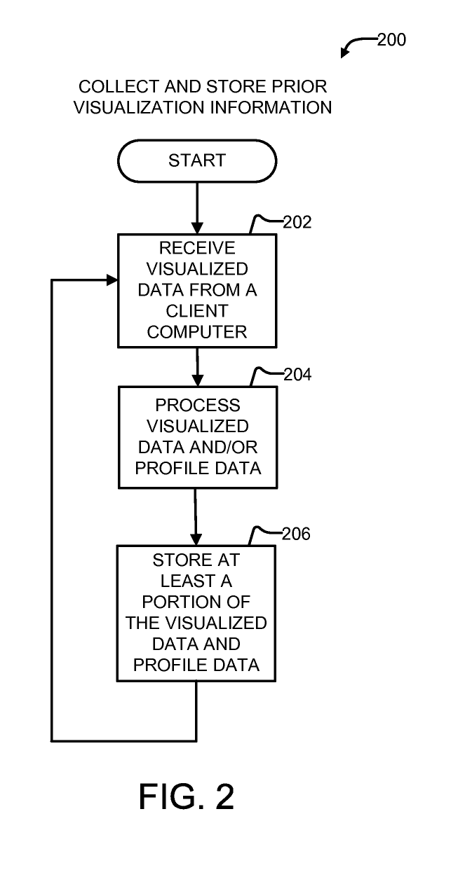

The visualized data 120 and results 121 can be submitted for transmission over a network (not shown in FIG. 1), in some configurations. The network may include a computer communications network such as the Internet, a local area network (“LAN”), wide area network (“WAN”), or any other type of network, and may be utilized to submit the visualized data 120 to the data processing system 140 for processing of data connections and query statements described therein, and subsequently, for returning results 121 which can be appropriately displayed at UI 102. Submission of visualized data 120 and results 121 are described more fully below with reference to FIG. 2.

As shown FIG. 1, profile data 124 may also be submitted to the data processing system 140. The profile data 124 may include contextual information, identification information, user profile data, or any other suitable information. The profile data 124 may also include metadata related to activities at a client 101, for example, activities related to communications between users, activities related to a particular group of users, or other activities that can be useful in determining visualization suggestions 125.

According to at least one configuration, the profile data 124 includes information related to common actions as related to visualized data. For example, the profile data 124 can include data describing a particular user's habits with regard to data visualizations, including, preferred forms of graphical elements such as charts and graphs, preferred formatting options for graphical elements such as date formats and axis formats, and other similar information.

According to another configuration, the profile data 124 includes data describing a user of a client computer 101, such as, employment data, employee identification data, employee group/committee data, and other similar data. Additionally, the profile data 124 may include enterprise or corporate information in some implementations. The profile data 124 may also include other forms of data without departing from the scope of this disclosure.

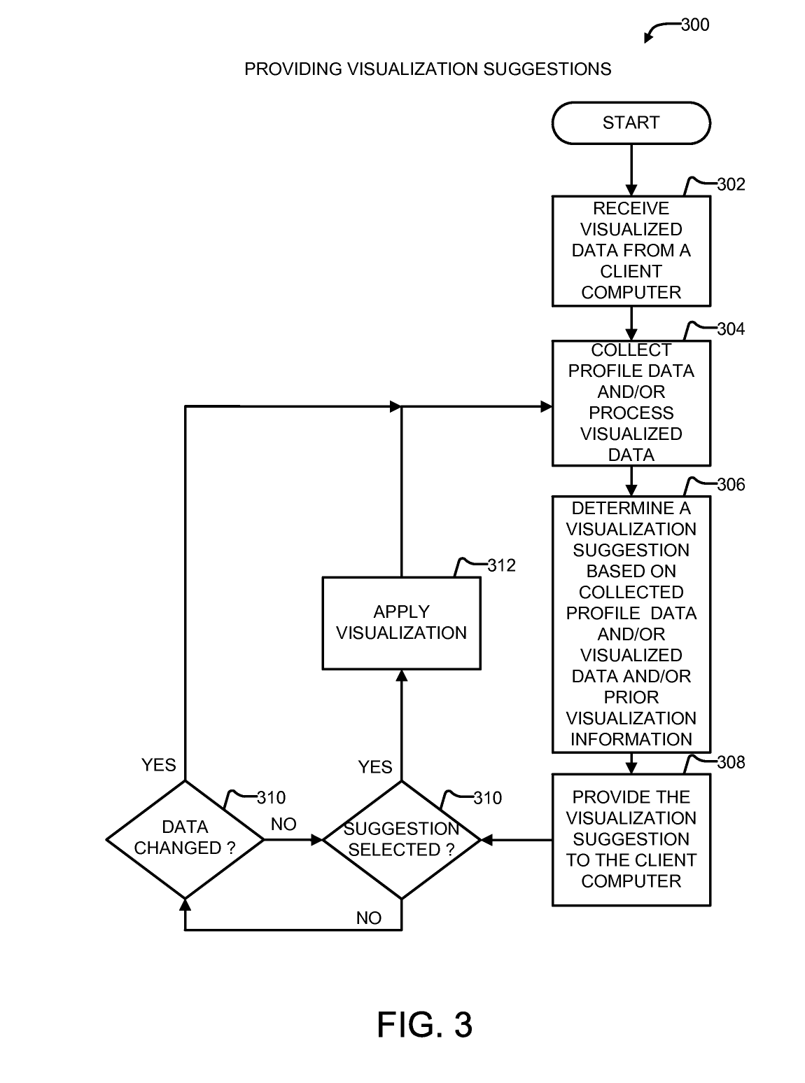

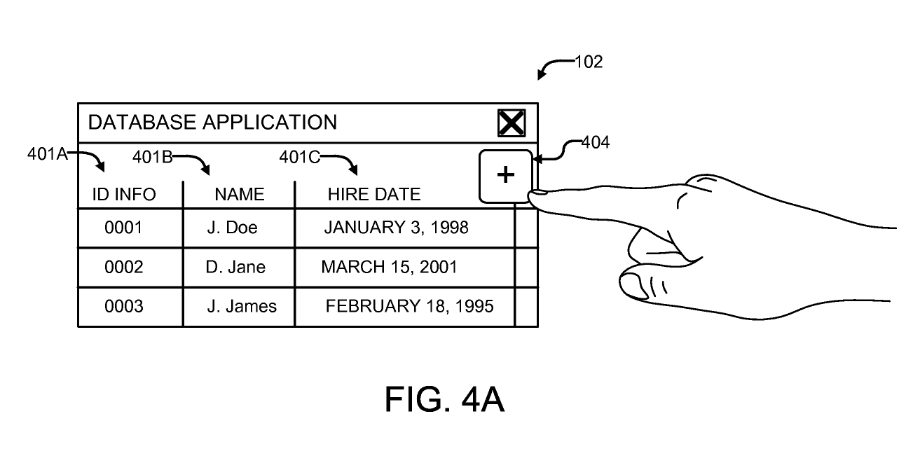

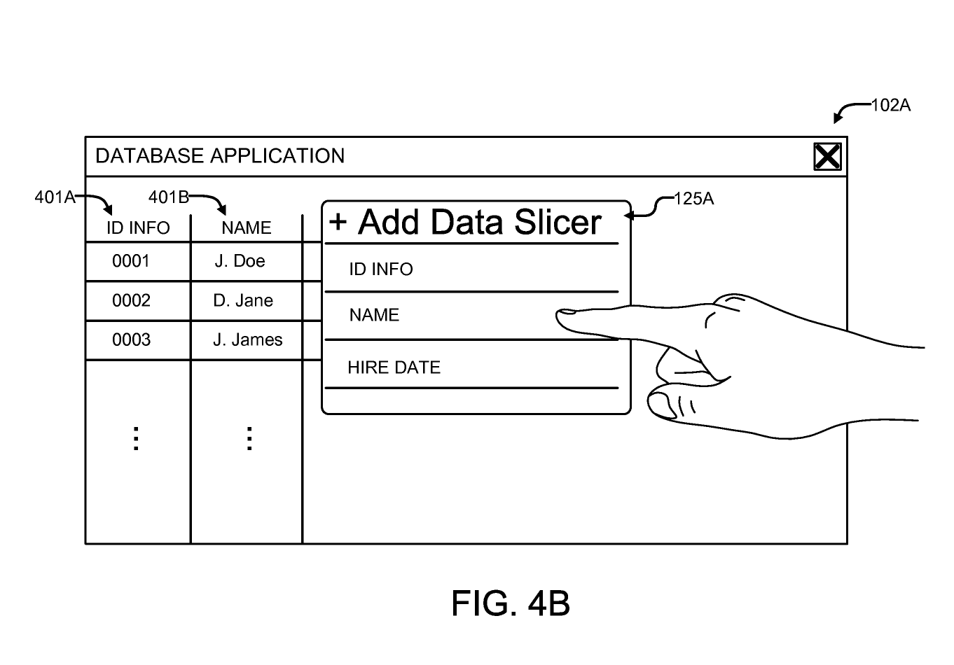

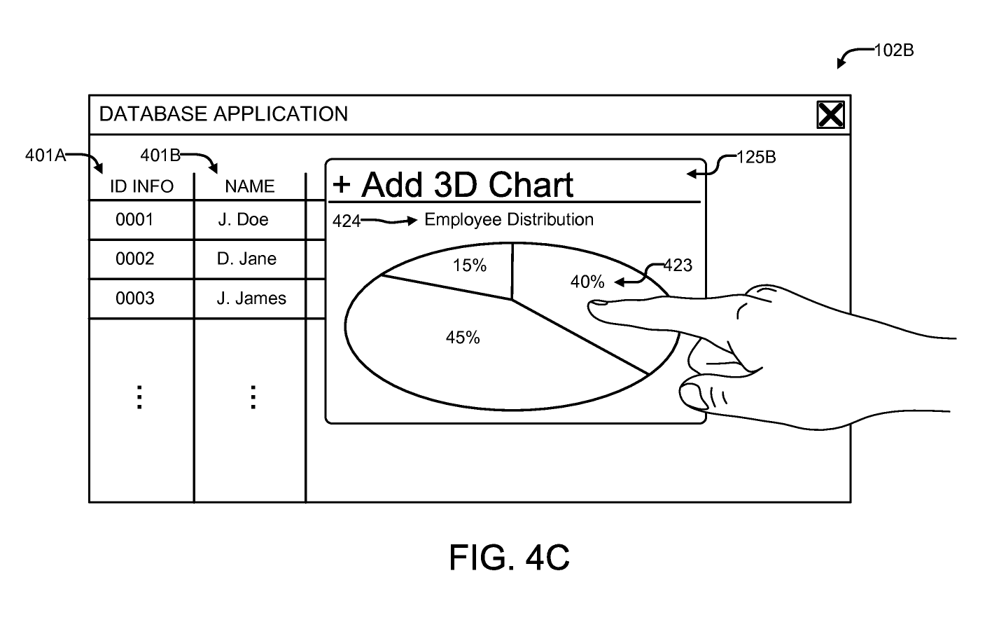

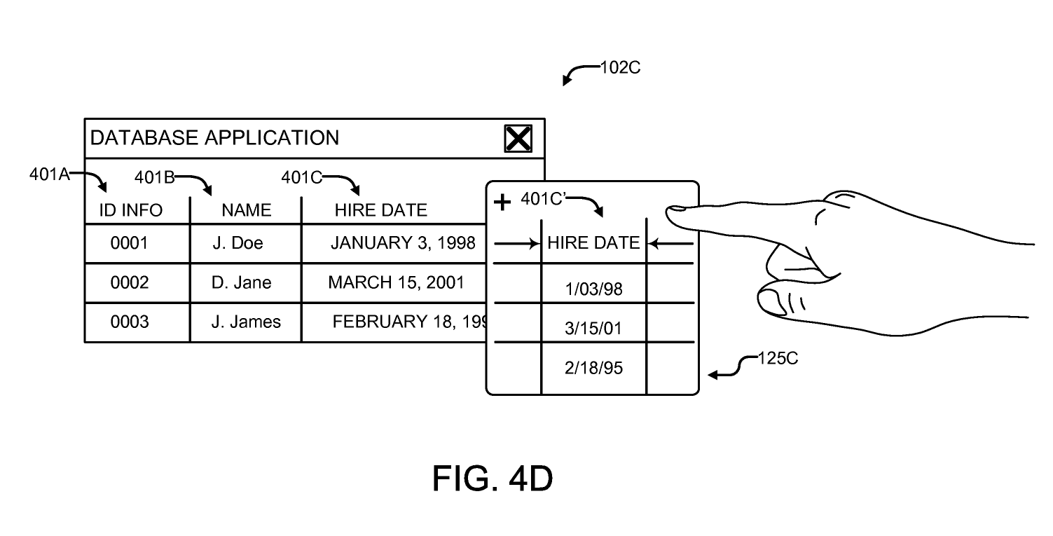

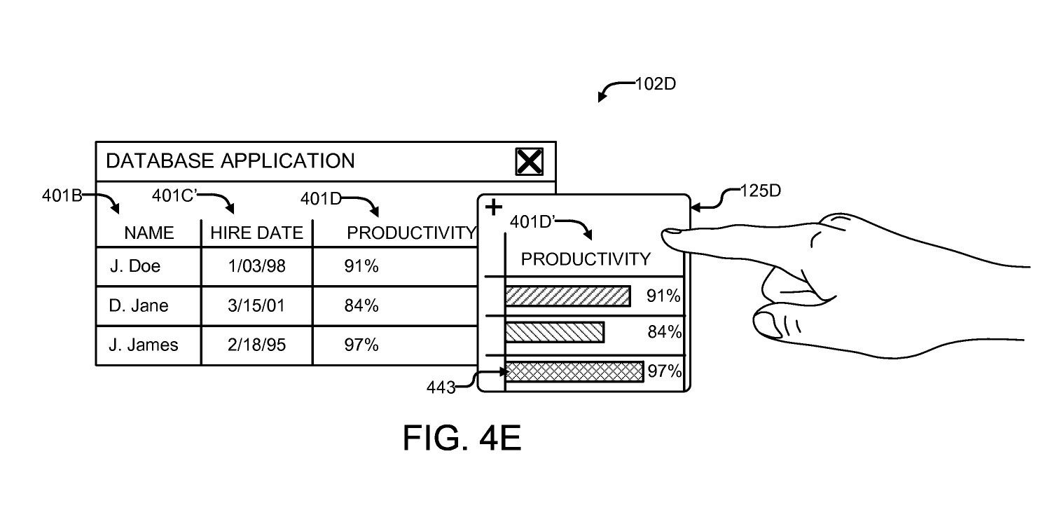

As described in detail below, the profile data 124 may be used to identify users or groups of users related to a user creating (or attempting to create) visualized data 120B. Responsive to analysis of the profile data 124, any data connections from visualized data 120B, and/or the prior visualization information 142, one or more visualization suggestions 125 may be returned to the client 101. Additionally, upon selection of any visualization suggestion 125, the visualized data 120B may be updated to reflect the selection/changes and transmitted to the data processing system 140. Thereafter, additional visualization suggestions 125 may be provided to the client 101, along with associated results 121B based on data connections described by the visualized data 120B. The provision of a visualization suggestion 125 is described more fully below with reference to FIGS. 3-4E.

As further illustrated in FIG. 1, the data processing system 140 includes several components configured to perform processing functions as described herein related to processing and storing visualized data 120, processing of profile data 124, returning results 121 and visualization suggestions 125, and potentially other functionality. For example, the data processing system 140 may be configured to receive and process the visualized data 120 (or any data connections, query statements, etc. specified therein) at one or more of a plurality of data sources 141 (which may be referred to herein in the singular as a “data source 141” and/or in the plural as the “data sources 141”).

Generally, a data source 141 receives visualized data 120, performs one or more queries based on query statements/instructions contained therein, and returns the results 121. The results 121 may be returned as data for display/visualization according to instructions, objects, or other attributes of the visualized data 120. Furthermore, according to aspects of the technologies presented herein, prior visualization information 142 may be populated with previous data visualizations and metadata describing profile data 124, data connections, and/or other attributes associated with the prior visualization information 142. Accordingly, at least a portion of the visualized data 120 may be stored as prior visualization information 142 alongside profile data 124 associated with clients 101 and users thereof.

It is noted that the acts described above as related to the data sources 141 and prior visualization information 142 can be continually performed according to some implementations. Thus, as visualized data 120 are received, one or more portions of graphical elements, visualization information, and the like, may be stored as prior visualization information 142, for use in providing visualization suggestions 125 as described in detail below. Additionally, prior visualization information 142 may include other information not directly attributed to storage based upon visualized data 120. For example, the prior visualization information 142 may include data obtained through scraping existing files for visualization information. This may be facilitated by visualization suggestion service layer 143 as described below, and may be performed in any suitable manner.

Generally, prior visualization information 142 can include prior formatting information, prior style information, prior layout information, prior summarization information, and/or prior graphical element information. This prior information can be stored based upon visualized data 120 or files scraped for graphical or visualization information.

As shown in FIG. 1, the data processing system 140 includes the visualization suggestion service layer 143 executing therein in one configuration. The visualization suggestion service layer 143 is a software routine or application, and may be separately integrated within each data source 141 (not illustrated) in some implementations. However, the visualization suggestion service layer 143 can also execute as a standalone visualization suggestion service layer (as illustrated) in some implementations.

The visualization suggestion service layer 143 is configured to process files which may contain visualized data, process profile data 124, and/or process visualized data 120B for storage at prior visualization information 142. The visualization suggestion service layer 143 may also be configured to process received profile data 124 and visualized data 120B, and to determine a visualization suggestion 125 based upon the visualized data 120B, the profile data 124, and/or stored prior visualization information 142. In order to provide this functionality, the visualization suggestion service layer 143 may compare information in the profile data 124, data connections contained or specified in the visualized data 120B, and/or prior visualization information 142 to identify one or more visualization suggestions 125. For example, the visualization suggestion service layer 143 may attempt to match prior visualized data 120 to visualized data 120B based on similar data connections, similar query statements, similar profile data 124, or other aspects.

If a match or closely related prior visualized data 120A is found, one or more data visualizations including charts, graphs, formatting, filtering, stylistic attributes, fonts, or other data visualizations may be selectively retrieved from the prior visualization information 142 and returned as the visualization suggestion 125. As a user selects or adds visualization suggestions 125 to visualized data 120B, a more complete visualization may be built according to existing formats, attributes, and styles.

It is noted that although described as visualization suggestions 125 being returned to a client for display as a suggestion, the same may be varied and provided as “smart defaults.” As used herein, the phrase “smart default” and variants thereof include default data visualizations rendered based on profile data 124, visualized data 120A, and/or prior visualization information 142. The visualization suggestions 125 can therefore also be used as smart defaults. For example, a user might select to add new data to a PivotTable or query for display. Thereafter, the visualization suggestion service layer 143 can direct the Pivot Table to add the requested data in a common location based on profile data 124, and with a preset aggregation (e.g., displayed as an average due to prior visualization information 142). Therefore the user may need not select or add an individual visualization suggestion 125, instead it is applied automatically as a smart default. Building the visualized data 120B through the suggestions 125 and/or smart defaults as described above is described more fully with reference to FIGS. 4A-4E.

Referring now to FIG. 2, additional details will be provided regarding the technologies presented herein for processing profile data 124 and visualized data 120 by the data processing system 140, and collecting and storing prior visualization information 142. In particular, FIG. 2 is a flow diagram showing aspects of one illustrative routine 200 for collecting and storing prior visualization information 142. As illustrated, the method 200 includes receiving visualized data 120A from a client computer 101A, at block 202. For example, the visualized data 120A includes data connections or query statements directed to at least one data source 141. Accordingly, the data source 141 receives and processes the visualized data 120A to produce results 121A. Thereafter, the UI 102A of the client 101A may display the results 121A as described in the visualized data 120A.

Additionally, in response to receipt of the visualized data 120A, the method 200 further includes processing the visualized data 120A and profile data 124, at block 204. The profile data 124 may take any of the forms described above, and may be collected by the data source 141 for storage as prior visualization information 142. Upon processing of the visualized data 120A and profile data 124, at least a portion of the received/processed visualized data 120A and the profile data 124 is stored as prior visualization information 142, at block 206. Additional forms of visualized data 120 may be received and processed as described above with relation to blocks 202-206. Furthermore, prior visualization information 142 can also include information not directly received as visualized data 120A, including, for example, data or information scraped from existing files having one or more data connections.

Generally, the portion of the visualized data 120A or scraped data stored as prior visualization information 142 may be varied according to any desirable characteristics. For example, individual graphical elements such as charts, graphs, and such, may be stored according to particular data connections described in the visualized data 120A, existing files, or profile data 124. Furthermore, an order of execution or order of inclusion of graphical elements may also be stored. For example, if a first user in a first group associated with profile data 124 and a particular data connection initially adds a pivot table with three data fields before adding a pie chart to the visualized data 120, the visualization suggestion 125 may include the same sequence of events to better aid other users. It should be understood that these are non-limiting examples of one possible implementation. Other portions, sequences, types, and/or forms of prior visualization information 142 are possible.

As described above, at least a portion of profile data 124 related to the client 101 and the visualized data 120A is stored as prior visualization information 142. The stored information can be used as described below to generate visualization suggestions 125 based on newly accessed/submitted visualized data 120B.

Turning now to FIG. 3, additional details will be provided regarding the technologies presented herein for processing profile data 124 and visualized data 120B to provide one or more visualization suggestions 125. In particular, FIG. 3 is a flow diagram showing aspects of one illustrative routine 300 for providing the visualization suggestions 125.

The method 300 includes receiving visualized data 120B from a client 101B at block 302. Although described as receiving visualized data 120B, it should be understood that the method 300, and block 302, may be adaptable to begin execution through opening of a file, manipulation of a file, action upon a visualization suggestion 125, action upon a data file, or any other suitable act through a client 101, application 103, and/or user interface 102. Accordingly block 302 can also include detecting access at a data source 141, initialization of a client 101, initialization of an application 103, or action through user interface 102. The access at the data source 141 can encompass a request for access to data stored at the data source 141, through, for example, user interfaces 102 or other suitable manners of data access.

The method 300 further includes collecting profile data 124 and/or processing visualized data 120B at block 304. For example, profile data 124 related to client 101 or a user thereof may be received at visualization suggestion service layer 143. Thereafter, the visualization suggestion service layer 143 can analyze the profile data 124, visualized data 120B, actions through user interface 102, and/or prior visualization information 142 to determine a visualization suggestion 125, at block 306. The visualization suggestion 125 is provided to the client 101 at block 308.

Generally, determining the visualization suggestion 125 may be based on any particular level of granularity desired in providing suggestions and aiding users in building visualized data 120B or data reports. At a basic level, the determining can include matching data access requests or data connections from visualized data 120B and prior visualization information 142.

Additionally, the determining can include interpreting manipulation of visualized data 120B such, as, for example, interpreting changes in format, display, or other attributes to determine a new visualization suggestion 125. As a non-limiting example of manipulation of visualized data 120B, a user may have previously added a Pivot Table for display of data. According to the particular data displayed in the Pivot Table, the visualization suggestion service layer 143 may determine that the particular data is usually displayed in a preferred hierarchy and having a preferred numerical format. Accordingly, the preferred hierarchy and numerical format may be returned as a visualization suggestion 125.

Further, the determining can include matching or attempting to match employee info, group info, relationships, or other connections through use of profile data 124 to determine the visualization suggestion 125. The determining can also include identifying correlations between ordering or arrangement of data connections, an order or workflow of query statements, or other attributes of the visualized data 120B. Other forms of determining suggestions 125 are also applicable, and are considered to be within the scope of this disclosure.

Upon action by the client 101 on the visualization suggestion 125 at block 310, the visualization suggestion service layer 143 may apply the visualization suggestion 125 at block 312 and continue providing additional suggestions through blocks 304-312. Additionally, if a user, instead of selecting a provided visualization suggestion 125 alters the visualized data 120B at block 310, additional or different suggestions may be determined through blocks 304-312. In this manner, many different visualization suggestions 125 related to actions at the client 101 and visualized data 120B may be provided by the visualization suggestion service layer 143, and differing forms of visualized data 120B may be more easily prepared by users or employees through the system 100.

FIGS. 4A-4E are UI diagrams showings aspects of several illustrative UIs, according to several configurations presented herein. The UIs described with relation to FIGS. 4A-4E may be arranged similar to a spreadsheet interface for a spreadsheet application having access to one or more data sources and/or data processing systems. Other UIs and interfaces are also applicable, and therefore, the present disclosure is not limited to the particular forms illustrated, but to any available form of interface.

Turning to FIG. 4A, a user interface 102 for providing a visualization suggestion will be described. As shown in FIG. 4A, the user interface 102 includes visualized data 401A-401C based on at least one data connection to a data source 141. The visualized data 401 is displayed in columns. As further shown, a visualization suggestion UI element 404 is rendered that indicates to a user that at least one visualization suggestion may be available based on any of the following: visualized data, data connections, data source access, profile data, manipulation of the visualized data 401, or other suitable attributes. Upon selection of the visualization suggestion UI element 404, visualization suggestions 125 may be identified and rendered as shown in FIGS. 4B-4E.

The user interface 102A of FIG. 4B illustrates the visualized data 401, and further includes a graphical representation of visualization suggestion 125A generated based upon the prior visualization information 142. Particularly, the visualization suggestion 125A includes a data slicer filtering element matched to the visualized data 401 based on one or more of the attributes described above. It is noted that although the visualization suggestion 125A has been illustrated as being related to filtering, that additional operations are also applicable including ordering, sorting, and other suitable operations. Additionally, particular field orderings and display widths of a table of visualized data 401 may also be presented as visualization suggestion 125A.

The user interface 102B of FIG. 4C comprises the visualized data 401, and further includes a graphical representation of visualization suggestion 125B retrieved from prior visualization information 142. The suggestion 125B includes the addition of a charting element 423 based on a new data connection to employee distribution information 424 based on the visualized data 401 and prior visualization information 142. It is noted that the charting element 423 can take a variety of forms based upon the attributes of the visualized data 401 and prior visualization information 142. For example, although particularly illustrated as a pie chart, linear graphs, plots, bar charts, or other charting elements are also applicable.

It is noted that any visualization suggestion 125 as described herein may also include a “ghost” rendering representative of the size, format, and style of the visualization suggestion 125. Accordingly, although the suggestion 125B is shown as a distinct rendering, the ghost rendering may be rendered “in-line” with the visualized data 401 to more closely represent a final look and feel of the user interface 102B after selection of the suggestion 125B. The ghost rendering is a visual rendering that is distinct from the visualized data 401. For example, and without limitation, the ghost rendering may be presented in a lighter shade or different color than the visualized data 401. The ghost rendering might also be indicated through the use of other visual attributes that are distinct from visual attributes utilized to render the visualized data 401.

The user interface 102C of FIG. 4D comprises the visualized data 401, and further includes a graphical representation of visualization suggestion 125C. The visualization suggestion 125C includes several suggestions including formatting of visualized data 401C to create visualized data 401C′ in a particular numerical format, with a reduced column width, and in a particular ordering. It should be understood that any of the visualization suggestions included in the rendering of suggestion 125C may also be separately provided by the visualization suggestion service layer 143, according to some implementations. For example, a particular column width may be presented as an individual suggestion 125 distinct from the visualization suggestions 125C. Additionally, although presented as numerical formatting of 401C′ in a “short date” format, other formatting suggestions are also applicable. Example formatting suggestions include numerical delimiters such as commas or periods for currency values or other numbers, a particular number of decimal places to display, appending a currency notation or other character, and other appropriate suggestions.

The user interface 102D of FIG. 4E comprises the visualized data 401B, 401C′, and visualized data 401D from a new or existing data connection to employee productivity information. As shown, due to the visualized data 401D, visualization suggestion 125D has been provided that suggests altering visualized data 401D to 401D′, having graphical bar elements 443 more clearly depicting percentages rendered thereon.

Other visualization suggestions 125 may be implemented according to any particular set of visualized data 401, prior visualization information 142, and/or profile data 124. The visualization suggestions 125 may include default formatting or default data fields based on visualized data 401 and matching prior visualization information 142. Furthermore, hierarchies can be identified in prior visualization information 142 to determine how best to present an ordering of information within visualization suggestions 125. Other visualization suggestions including: implementing data fields to either rows or columns, aggregating data fields by count, sum, average, or other functions, number formatting, text formatting, data plotting, or any other suitable form of a visualization suggestion may also be applicable.

As described above, through analysis of data connections and other attributes of visualized data 120B, different visualization suggestions based on prior visualization information 142 can be provided. The visualization suggestions may be based on formatting, style, placement, ordering, and/or other attributes of previously created visualized data 120A. The suggestions 125 may be determined by identifying matching profile data 124, data connections, or other correlations, and may be configured to leverage the structure of previously visualized data to promote consistency and increase the efficiency of novice users (or even more advanced users) when creating data reports or other forms of visualized data.

It should be appreciated that the logical operations described above may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the FIGS. and described herein. These operations may also be performed in a different order than those described herein.

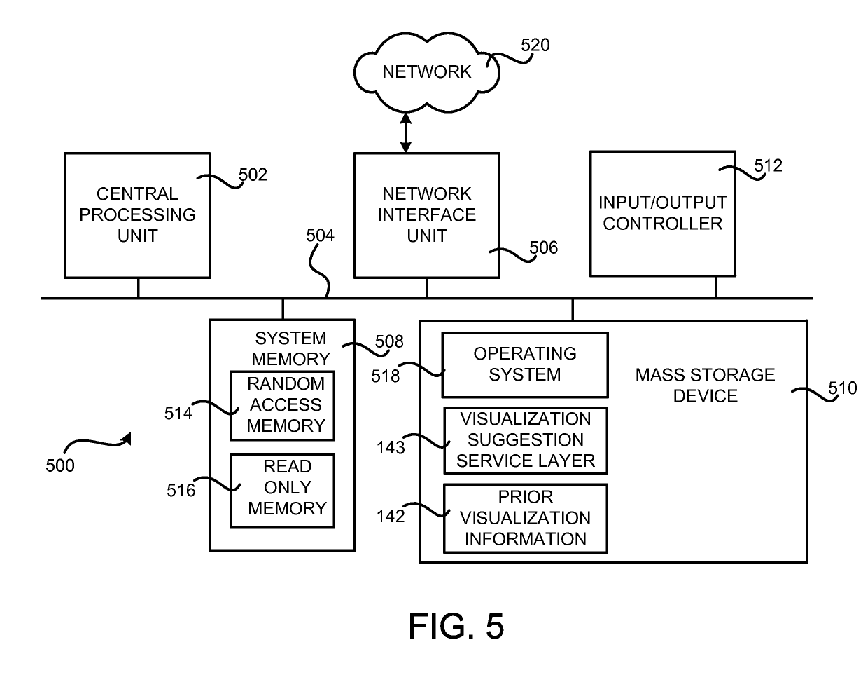

FIG. 5 illustrates an illustrative computer architecture 500 for a device capable of executing the software components described herein for providing visualization suggestions. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 518 and one or more application programs including, but not limited to, visualization suggestion service layer 143 and prior visualization information 142.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 500. For purposes of the claims, the phrase “computer storage medium,” and variations thereof, does not include waves or signals per se and/or communication media.

According to various technologies, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

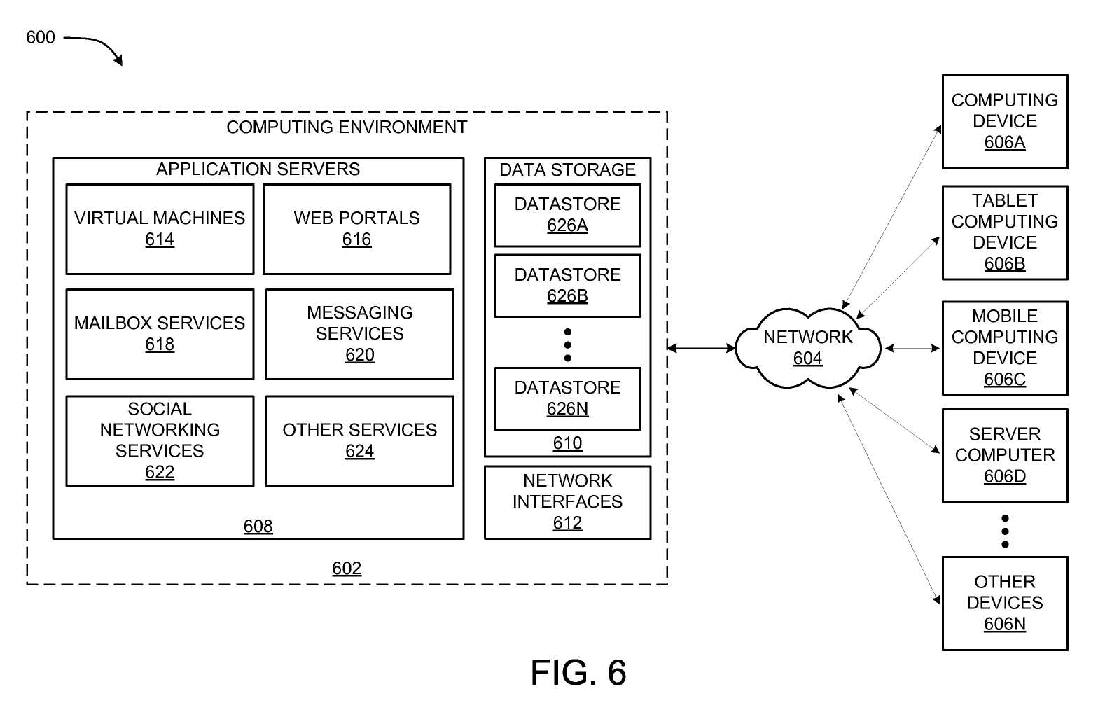

FIG. 6 illustrates an illustrative distributed computing environment 600 capable of executing the software components described herein for providing visualization suggestions. Thus, the distributed computing environment 600 illustrated in FIG. 6 can be used to provide the functionality described herein with respect to the system 100. The distributed computing environment 600 thus may be utilized to execute any aspects of the software components presented herein.

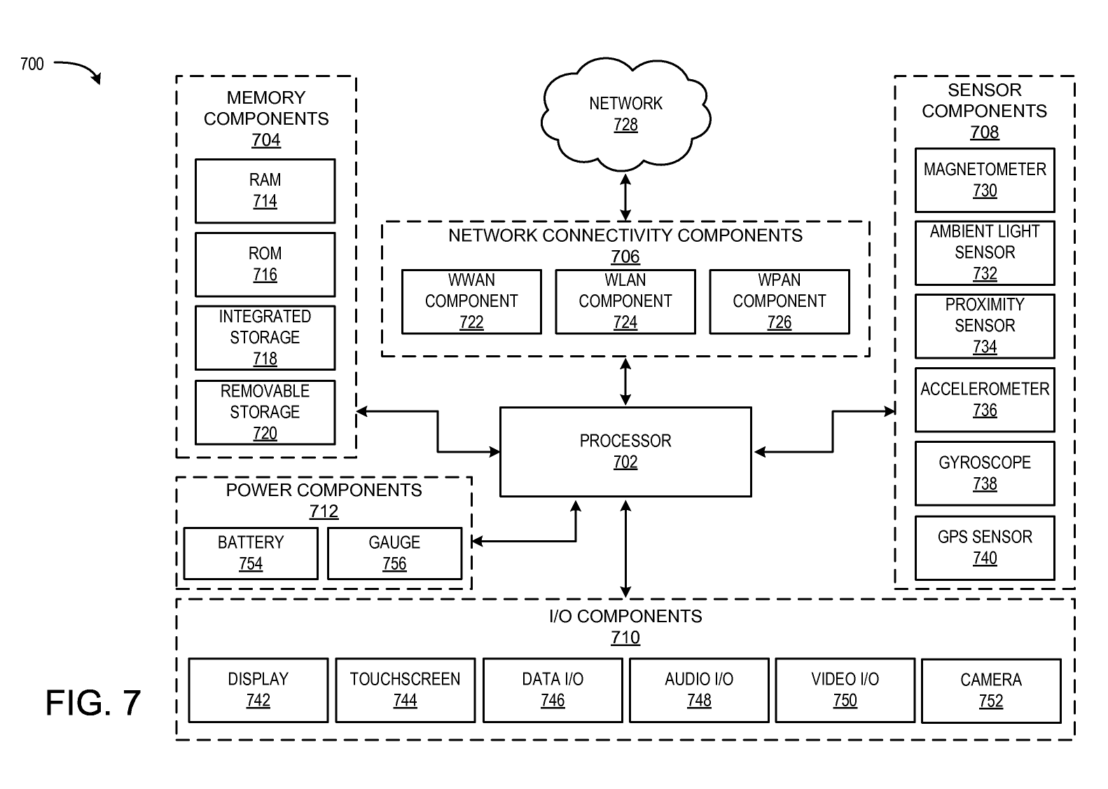

According to various implementations, the distributed computing environment 600 includes a computing environment 602 operating on, in communication with, or as part of the network 604. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In the illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing the functionality described herein for providing visualization suggestions. It should be understood that this example is illustrative, and should not be construed as being limiting in any way. The application servers 608 also host or provide access to one or more Web portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also can include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some technologies, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other technologies, the social networking services 622 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from MICROSOFT CORPORATION of Redmond, Wash. Other services are possible and are contemplated.

The social networking services 622 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above technologies are illustrative, and should not be construed as being limited in any way.

As shown in FIG. 6, the application servers 608 also can host other services, applications, portals, and/or other resources (“other resources”) 624. The other resources 624 can include, but are not limited to, the visualization suggestions service layer 143 and prior visualization information 142. It thus can be appreciated that the computing environment 602 can provide integration of the concepts and technologies disclosed herein provided herein for providing visualization suggestions with various mailbox, messaging, social networking, and/or other services or resources. For example, the concepts and technologies disclosed herein for providing visualization suggestions may leverage the structure of visualized data shared amongst friends in a social network, across members of a class identified through social networking data, and/or otherwise identified through social networking data.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various technologies of the concepts and technologies disclosed herein enable any device configured to access the distributed computing environment 600 to utilize the functionality described herein for providing visualization suggestions.

Turning now to FIG. 7, an illustrative computing device architecture 700 for a computing device that is capable of executing various software components described herein for providing visualization suggestions. The computing device architecture 700 is applicable to computing devices that facilitate mobile computing due, in part, to form factor, wireless connectivity, and/or battery-powered operation. In some technologies, the computing devices include, but are not limited to, mobile telephones, tablet devices, slate devices, portable video game devices, and the like. Moreover, the computing device architecture 700 is applicable to any of the clients 706 shown in FIG. 6. Furthermore, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some technologies, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some technologies, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“D”) modeling applications, and the like. In some technologies, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some technologies, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some technologies, the processor 702 is fabricated, in part, utilizing a package-on-package (“PoP”) integrated circuit packaging technique. Moreover, the processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some technologies, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some technologies, the RAM 714 or a portion thereof, the ROM 716 or a portion thereof, and/or some combination the RAM 714 and the ROM 716 is integrated in the processor 702. In some technologies, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some technologies, the removable storage 720 is provided in lieu of the integrated storage 718. In other technologies, the removable storage 720 is provided as additional optional storage. In some technologies, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various technologies, the operating system includes, but is not limited to, SYMBIAN OS from SYMBIAN LIMITED, WINDOWS MOBILE OS from MICROSOFT CORPORATION of Redmond, Wash., WINDOWS PHONE OS from MICROSOFT CORPORATION, the WINDOWS operating system from MICROSOFT CORPORATION, PALM WEBOS from HEWLETT-PACKARD COMPANY of Palo Alto, Calif., BLACKBERRY OS from RESEARCH IN MOTION LIMITED of Waterloo, Ontario, Canada, IOS from APPLE INC. of Cupertino, Calif., and ANDROID OS from GOOGLE INC. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from a network 728, which may be a WWAN, a WLAN, or a WPAN. Although a single network 728 is illustrated, the network connectivity components 706 may facilitate simultaneous communication with multiple networks. For example, the network connectivity components 706 may facilitate simultaneous communications with multiple networks via one or more of a WWAN, a WLAN, or a WPAN.

The network 728 may be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 728 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 728 may be configured to provide voice and/or data communications with any combination of the above technologies. The network 728 may be configured to or adapted to provide voice and/or data communications in accordance with future generation technologies.

In some technologies, the WWAN component 722 is configured to provide dual-multi-mode connectivity to the network 728. For example, the WWAN component 722 may be configured to provide connectivity to the network 728, wherein the network 728 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 728 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some technologies, the WLAN is implemented utilizing one or more wireless WI-FI access points. In some technologies, one or more of the wireless WI-FI access points are another computing device with connectivity to a WWAN that are functioning as a WI-FI hotspot. The WLAN component 724 is configured to connect to the network 728 via the WI-FI access points. Such connections may be secured via various encryption technologies including, but not limited, WI-FI Protected Access (“WPA”), WPA2, Wired Equivalent Privacy (“WEP”), and the like.

The network 728 may be a WPAN operating in accordance with Infrared Data Association (“IrDA”), BLUETOOTH, wireless Universal Serial Bus (“USB”), Z-Wave, ZIGBEE, or some other short-range wireless technology. In some technologies, the WPAN component 726 is configured to facilitate communications with other devices, such as peripherals, computers, or other computing devices via the WPAN.

The sensor components 708 include a magnetometer 730, an ambient light sensor 732, a proximity sensor 734, an accelerometer 736, a gyroscope 738, and a Global Positioning System sensor (“GPS sensor”) 740. It is contemplated that other sensors, such as, but not limited to, temperature sensors or shock detection sensors, also may be incorporated in the computing device architecture 700.

The magnetometer 730 is configured to measure the strength and direction of a magnetic field. In some technologies the magnetometer 730 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 730 are contemplated.

The ambient light sensor 732 is configured to measure ambient light. In some technologies, the ambient light sensor 732 provides measurements to an application program stored within one the memory components 704 in order to automatically adjust the brightness of a display (described below) to compensate for low-light and high-light environments. Other uses of measurements obtained by the ambient light sensor 732 are contemplated.

The proximity sensor 734 is configured to detect the presence of an object or thing in proximity to the computing device without direct contact. In some technologies, the proximity sensor 734 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 734 are contemplated.

The accelerometer 736 is configured to measure proper acceleration. In some technologies, output from the accelerometer 736 is used by an application program as an input mechanism to control some functionality of the application program. For example, the application program may be a video game in which a character, a portion thereof, or an object is moved or otherwise manipulated in response to input received via the accelerometer 736. In some technologies, output from the accelerometer 736 is provided to an application program for use in switching between landscape and portrait modes, calculating coordinate acceleration, or detecting a fall. Other uses of the accelerometer 736 are contemplated.

The gyroscope 738 is configured to measure and maintain orientation. In some technologies, output from the gyroscope 738 is used by an application program as an input mechanism to control some functionality of the application program. For example, the gyroscope 738 can be used for accurate recognition of movement within a 3D environment of a video game application or some other application. In some technologies, an application program utilizes output from the gyroscope 738 and the accelerometer 736 to enhance control of some functionality of the application program. Other uses of the gyroscope 738 are contemplated.

The GPS sensor 740 is configured to receive signals from GPS satellites for use in calculating a location. The location calculated by the GPS sensor 740 may be used by any application program that requires or benefits from location information. For example, the location calculated by the GPS sensor 740 may be used with a navigation application program to provide directions from the location to a destination or directions from the destination to the location. Moreover, the GPS sensor 740 may be used to provide location information to an external location-based service, such as E911 service. The GPS sensor 740 may obtain location information generated via WI-FI, WIMAX, and/or cellular triangulation techniques utilizing one or more of the network connectivity components 706 to aid the GPS sensor 740 in obtaining a location fix. The GPS sensor 740 may also be used in Assisted GPS (“A-GPS”) systems.

The I/O components 710 include a display 742, a touchscreen 744, a data I/O interface component (“data I/O”) 746, an audio I/O interface component (“audio I/O”) 748, a video I/O interface component (“video I/O”) 750, and a camera 752. In some technologies, the display 742 and the touchscreen 744 are combined. In some technologies two or more of the data I/O component 746, the audio I/O component 748, and the video I/O component 750 are combined. The I/O components 710 may include discrete processors configured to support the various interface described below, or may include processing functionality built-in to the processor 702.

The display 742 is an output device configured to present information in a visual form. In particular, the display 742 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some technologies, the display 742 is a liquid crystal display (“LCD”) utilizing any active or passive matrix technology and any backlighting technology (if used). In some technologies, the display 742 is an organic light emitting diode (“OLED”) display. Other display types are contemplated.

The touchscreen 744 is an input device configured to detect the presence and location of a touch. The touchscreen 744 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some technologies, the touchscreen 744 is incorporated on top of the display 742 as a transparent layer to enable a user to use one or more touches to interact with objects or other information presented on the display 742. In other technologies, the touchscreen 744 is a touch pad incorporated on a surface of the computing device that does not include the display 742. For example, the computing device may have a touchscreen incorporated on top of the display 742 and a touch pad on a surface opposite the display 742.

In some technologies, the touchscreen 744 is a single-touch touchscreen. In other technologies, the touchscreen 744 is a multi-touch touchscreen. In some technologies, the touchscreen 744 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 744. As such, a developer may create gestures that are specific to a particular application program.

In some technologies, the touchscreen 744 supports a tap gesture in which a user taps the touchscreen 744 once on an item presented on the display 742. The tap gesture may be used for various reasons including, but not limited to, opening or launching whatever the user taps. In some technologies, the touchscreen 744 supports a double tap gesture in which a user taps the touchscreen 744 twice on an item presented on the display 742. The double tap gesture may be used for various reasons including, but not limited to, zooming in or zooming out in stages. In some technologies, the touchscreen 744 supports a tap and hold gesture in which a user taps the touchscreen 744 and maintains contact for at least a pre-defined time. The tap and hold gesture may be used for various reasons including, but not limited to, opening a context-specific menu.

In some technologies, the touchscreen 744 supports a pan gesture in which a user places a finger on the touchscreen 744 and maintains contact with the touchscreen 744 while moving the finger on the touchscreen 744. The pan gesture may be used for various reasons including, but not limited to, moving through screens, images, or menus at a controlled rate. Multiple finger pan gestures are also contemplated. In some technologies, the touchscreen 744 supports a flick gesture in which a user swipes a finger in the direction the user wants the screen to move. The flick gesture may be used for various reasons including, but not limited to, scrolling horizontally or vertically through menus or pages. In some technologies, the touchscreen 744 supports a pinch and stretch gesture in which a user makes a pinching motion with two fingers (e.g., thumb and forefinger) on the touchscreen 744 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 744. As such, the above gestures should be understood as being illustrative and should not be construed as being limiting in any way.

The data I/O interface component 746 is configured to facilitate input of data to the computing device and output of data from the computing device. In some technologies, the data I/O interface component 746 includes a connector configured to provide wired connectivity between the computing device and a computer system, for example, for synchronization operation purposes. The connector may be a proprietary connector or a standardized connector such as USB, micro-USB, mini-USB, or the like. In some technologies, the connector is a dock connector for docking the computing device with another device such as a docking station, audio device (e.g., a digital music player), or video device.

The audio I/O interface component 748 is configured to provide audio input and/or output capabilities to the computing device. In some technologies, the audio I/O interface component 746 includes a microphone configured to collect audio signals. In some technologies, the audio I/O interface component 746 includes a headphone jack configured to provide connectivity for headphones or other external speakers. In some technologies, the audio interface component 748 includes a speaker for the output of audio signals. In some technologies, the audio I/O interface component 746 includes an optical audio cable out.

The video I/O interface component 750 is configured to provide video input and/or output capabilities to the computing device. In some technologies, the video I/O interface component 750 includes a video connector configured to receive video as input from another device (e.g., a video media player such as a DVD or BLURAY player) or send video as output to another device (e.g., a monitor, a television, or some other external display). In some technologies, the video I/O interface component 750 includes a High-Definition Multimedia Interface (“HDMI”), mini-HDMI, micro-HDMI, DisplayPort, or proprietary connector to input/output video content. In some technologies, the video I/O interface component 750 or portions thereof is combined with the audio I/O interface component 748 or portions thereof.

The camera 752 can be configured to capture still images and/or video. The camera 752 may utilize a charge coupled device (“CCD”) or a complementary metal oxide semiconductor (“CMOS”) image sensor to capture images. In some technologies, the camera 752 includes a flash to aid in taking pictures in low-light environments. Settings for the camera 752 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 754, which can be connected to a battery gauge 756. The batteries 754 may be rechargeable or disposable. Rechargeable battery types include, but are not limited to, lithium polymer, lithium ion, nickel cadmium, and nickel metal hydride. Each of the batteries 754 may be made of one or more cells.

The battery gauge 756 can be configured to measure battery parameters such as current, voltage, and temperature. In some technologies, the battery gauge 756 is configured to measure the effect of a battery's discharge rate, temperature, age and other factors to predict remaining life within a certain percentage of error. In some technologies, the battery gauge 756 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via a power I/O component 744.

Based on the foregoing, it should be appreciated that technologies for providing visualization suggestions have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The technologies disclosed herein may be described as set forth in the following clauses:

Clause 1. A computer-implemented method for providing visualization suggestions, the method comprising:

receiving visualized data, the visualized data having profile data associated therewith and having at least one data connection to a data source associated therewith;

identifying prior visualization information related to at least one of the profile data and the at least one data connection;

determining a visualization suggestion based on the identified prior visualization information; and

providing the visualization suggestion.

Clause 2. The computer-implemented method according to clause 1, wherein the profile data comprises metadata describing identity data or contextual information.

Clause 3. The computer-implemented method according to any of clauses 1-2, wherein the prior visualization information comprises at least one of prior formatting information, prior style information, prior layout information, prior summarization information, or prior graphical element information.

Clause 4. The computer-implemented method according to any of clauses 1-3, wherein determining the visualization suggestion comprises:

determining that at least a portion of the profile data is associated with a portion of the prior visualization information; and

generating the visualization suggestion based, at least in part, on the portion of the prior visualization information.

Clause 5. The computer-implemented method according to any of clauses 1-4, wherein determining the visualization suggestion comprises:

determining that at least a portion of the prior visualization information includes a data connection related to the at least one data connection; and

generating the visualization suggestion to include a structural or graphical element of the prior visualization information associated with the related data connection.

Clause 6. The computer-implemented method according to any of clauses 1-5, wherein determining the visualization suggestion comprises:

determining that a portion of the prior visualization information is associated with the profile data;

determining that the portion of the prior visualization information includes a data connection related to the at least one data connection; and

generating the visualization suggestion to include a structural or graphical element of the prior visualization information associated with the related data connection.

Clause 7. The computer-implemented method according to any of clauses 1-6, further comprising providing the visualization suggestion for display through a user interface (UI) element.

Clause 8. The computer-implemented method according to any of clauses 1-7, wherein the UI element comprises a ghost rendering or inline rendering representative of the size, format, and style of the visualization suggestion or a selectable graphic rendering representative of the visualization suggestion.

Clause 9. The computer-implemented method according to any of clauses 1-8, further comprising:

receiving a selection of the visualization suggestion;

applying the visualization suggestion to the visualized data;

determining an additional visualization suggestion for the visualized data based on the applied visualization suggestion, the at least one data connection, and the profile data; and

providing the additional visualization suggestion.

Clause 10. The computer-implemented method according to any of clauses 1-9, wherein the received visualized data includes a plurality of data connections to a plurality of data sources, and wherein the method further comprises:

identifying prior visualization information related to the plurality of data connections;

determining a plurality of visualization suggestions based on the identified prior visualization information; and

providing the plurality of visualization suggestions.

Clause 11. A data processing system configured to provide visualization suggestions, the system comprising:

at least one computer executing a visualization suggestion service layer configured to

receive visualized data, the visualized data having at least one data connection to a data source associated therewith,

identify prior visualization information related to the at least one data connection,

determine a visualization suggestion based on the identified prior visualization information, and

provide the visualization suggestion.

Clause 12. The data processing system according to clause 11, wherein the at least one data connection comprises a query statement from the received visualized data.

Clause 13. The data processing system according to any of clauses 11-12, wherein determining the visualization suggestion comprises:

determining that a portion of the prior visualization information includes a data connection related to the at least one data connection; and

generating the visualization suggestion based, at least in part, on the portion of the prior visualization information.

Clause 14. The data processing system according to any of clauses 11-13, wherein the prior visualization information comprises at least one of prior formatting information, prior style information, prior layout information, prior summarization information, and prior graphical element information.

Clause 15. The data processing system according to any of clauses 11-14, wherein receiving the visualized data comprises receiving a query statement associated with the visualized data, and wherein determining the visualization suggestion comprises:

determining that a portion of the prior visualization information includes a query statement matching the received query statement; and

generating the visualization suggestion based, at least in part, on the portion of the prior visualization information.

Clause 16. The data processing system according to any of clauses 11-15, wherein the visualization suggestion service layer is further configured to:

receive a selection of the visualization suggestion;

apply the visualization suggestion to the visualized data;

determine an additional visualization suggestion for the visualized data based on the applied visualization suggestion and the at least one data connection; and

provide the additional visualization suggestion.

Clause 17. A computer-implemented method for providing visualization suggestions, the method comprising:

storing prior visualization information, the prior visualization information comprising profile data and visualizations for a plurality of data connections;

determining at least one visualization suggestion for visualized data, wherein the visualization suggestion comprises a selectable graphical suggestion for inclusion in the visualized data matched according to content of the visualized data and the prior visualization information; and

providing the at least one visualization suggestion to a client device configured to graphically display the visualization suggestion through a user-interface (UI) configured to receive selections of individual visualization suggestions of displayed visualization suggestions.

Clause 18. The computer-implemented method according to clause 17, wherein the profile data comprises metadata describing identity data or contextual information for a client computer implementing at least one of the plurality of data connections.

Clause 19. The computer-implemented method according to any of clauses 17-18, wherein the prior visualization information further comprises at least one of prior formatting information, prior style information, prior layout information, prior summarization information, or prior graphical element information.

Clause 20. The computer-implemented method according to any of clauses 17-19, wherein determining the visualization suggestion comprises:

determining that at least a portion of the prior visualization information is associated with the visualized data; and

generating the visualization suggestions based, at least in part, on the portion of the prior visualization information.

The subject matter described above is provided by way of illustration only and should not be construed as limiting. Various modifications and changes may be made to the subject matter described herein without following the example technologies and applications illustrated and described, and without departing from the true spirit and scope of the present invention, which is set forth in the following claims.

What is claimed is:

1. A computer-implemented method for providing visualization suggestions, the method comprising:
receiving visualized data, the visualized data having profile data associated therewith and having at least one data connection to a data source associated therewith;
identifying prior visualization information related to at least one of the profile data and the at least one data connection;
determining a visualization suggestion based on the identified prior visualization information; and
providing the visualization suggestion.

2. The computer-implemented method of claim 1, wherein the profile data comprises metadata describing identity data or contextual information.

3. The computer-implemented method of claim 1, wherein the prior visualization information comprises at least one of prior formatting information, prior style information, prior layout information, prior summarization information, or prior graphical element information.

4. The computer-implemented method of claim 1, wherein determining the visualization suggestion comprises:
determining that at least a portion of the profile data is associated with a portion of the prior visualization information; and
generating the visualization suggestion based, at least in part, on the portion of the prior visualization information.

5. The computer-implemented method of claim 1, wherein determining the visualization suggestion comprises:
determining that at least a portion of the prior visualization information includes a data connection related to the at least one data connection; and
generating the visualization suggestion to include a structural or graphical element of the prior visualization information associated with the related data connection.

6. The computer-implemented method of claim 1, wherein determining the visualization suggestion comprises:
determining that a portion of the prior visualization information is associated with the profile data;
determining that the portion of the prior visualization information includes a data connection related to the at least one data connection; and
generating the visualization suggestion to include a structural or graphical element of the prior visualization information associated with the related data connection.

7. The computer-implemented method of claim 1, further comprising providing the visualization suggestion for display through a user interface (UI) element.

8. The computer-implemented method of claim 7, wherein the UI element comprises:
a ghost rendering or inline rendering representative of the size, format, and style of the visualization suggestion; or
a selectable graphic rendering representative of the visualization suggestion.

9. The computer-implemented method of claim 1, further comprising:
receiving a selection of the visualization suggestion;
applying the visualization suggestion to the visualized data;
determining an additional visualization suggestion for the visualized data based on the applied visualization suggestion, the at least one data connection, and the profile data; and
providing the additional visualization suggestion.

10. The computer-implemented method of claim 1, wherein the received visualized data includes a plurality of data connections to a plurality of data sources, and wherein the method further comprises:
identifying prior visualization information related to the plurality of data connections;
determining a plurality of visualization suggestions based on the identified prior visualization information; and
providing the plurality of visualization suggestions.

11. A data processing system configured to provide visualization suggestions, the system comprising:
at least one computer executing a visualization suggestion service layer configured to
receive visualized data from a client computer, the visualized data having at least one data connection to a data source associated therewith,
identify prior visualization information related to the at least one data connection,
determine a visualization suggestion based on the identified prior visualization information, and
provide the visualization suggestion.

12. The data processing system of claim 11, wherein the at least one data connection comprises a query statement from the received visualized data.

13. The data processing system of claim 11, wherein determining the visualization suggestion comprises:
determining that a portion of the prior visualization information includes a data connection related to the at least one data connection; and
generating the visualization suggestion based, at least in part, on the portion of the prior visualization information.

14. The data processing system of claim 11, wherein the prior visualization information comprises at least one of prior formatting information, prior style information, prior layout information, prior summarization information, or prior graphical element information.

15. The data processing system of claim 11, wherein receiving the visualized data comprises receiving a query statement associated with the visualized data, and wherein determining the visualization suggestion comprises:
determining that a portion of the prior visualization information includes a query statement matching the received query statement; and
generating the visualization suggestion based, at least in part, on the portion of the prior visualization information.

16. The data processing system of claim 11, wherein the visualization suggestion service layer is further configured to:
receive a selection of the visualization suggestion;
apply the visualization suggestion to the visualized data;
determine an additional visualization suggestion for the visualized data based on the applied visualization suggestion and the at least one data connection; and
provide the additional visualization suggestion.

17. A computer-implemented method for providing visualization suggestions, the method comprising:
storing prior visualization information, the prior visualization information comprising profile data and visualizations for a plurality of data connections;
determining at least one visualization suggestion for visualized data, wherein the visualization suggestion comprises a selectable graphical suggestion for inclusion in the visualized data matched according to content of the visualized data and the prior visualization information; and
providing the at least one visualization suggestion to a client device configured to graphically display the visualization suggestion through a user-interface (UI) configured to receive selections of individual visualization suggestions of displayed visualization suggestions.

18. The computer-implemented method of claim 17, wherein the profile data comprises metadata describing identity data or contextual information for a client computer implementing at least one of the plurality of data connections.

19. The computer-implemented method of claim 17, wherein the prior visualization information further comprises at least one of prior formatting information, prior style information, prior layout information, prior summarization information, or prior graphical element information.

20. The computer-implemented method of claim 17, wherein determining the visualization suggestion comprises:
determining that at least a portion of the prior visualization information is associated with the visualized data; and
generating the visualization suggestion based, at least in part, on the portion of the prior visualization information.
